(19) United States
(12) Patent Application Publication
(10) Pub. No.: US 2025/0107568 A1
(43) Pub. Date: Apr. 3, 2025

(54) AEROSOL GENERATING APPARATUS AND HEATER FOR AEROSOL GENERATING APPARATUS

(71) Applicant: SHENZHEN FIRST UNION TECHNOLOGY CO., LTD., Shenzhen, Guangdong Province (CN)

(72) Inventors: Jian WU, Shenzhen, Guangdong Province (CN); Shuyuan ZHANG, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/730,156

(22) PCT Filed: Jan. 10, 2023
(86) PCT No.: PCT/CN2023/071697

§ 371 Date: Jul. 18, 2024

(30) Foreign Application Priority Data
Jan. 24, 2022 (CN) 202210078134.X

(51) Int. Cl. A24F 40/46; A24F 40/10; A24F 40/42

(52) U.S. Cl. CPC A24F 40/46; A24F 40/10; A24F 40/42

(57) ABSTRACT

An aerosol generating apparatus and a heater therefor are provided. The aerosol generating apparatus includes: a chamber configured to receive an aerosol-generating product; and a heater at least partially extending into the chamber for insertion into the aerosol-generating product to heat the aerosol-generating product. The heater has a free front end located in the chamber and a tail end away from the free front end. The heater includes a housing element extending between the free front end and the tail end and at least partially defining an outer surface of the heater. The housing element is formed by winding a sheet including a metal or an alloy. In the present aerosol generating apparatus, the housing element of the heater formed by winding the sheet having the metal or the alloy is more convenient to manufacture than conventional ceramic or stainless steel housings formed by moulding or machining.

### CROSS-REFERENCE TO RELATED APPLICATIONS

This application claims priority to Chinese Patent Application No. 202210078134.X, filed with the China National Intellectual Property Administration on Jan. 24, 2022 and entitled “AEROSOL GENERATING APPARATUS AND HEATER FOR AEROSOL GENERATING APPARATUS”, which is incorporated herein by reference in its entirety.

### TECHNICAL FIELD

Embodiments of this application relate to the technical field of heat-not-burn cigarette devices, and in particular, to an aerosol generating apparatus and a heater for an aerosol generating apparatus.

### BACKGROUND

During use of smoking products (such as cigarettes or cigars), tobacco is burnt to produce smoke. Attempts are made to manufacture products that release compounds without burning of tobacco to replace these tobacco-burning products.

A heating apparatus is an example of the products, which releases compounds by heating rather than burning materials. For example, the materials may be tobacco or non-tobacco products that may or may not include nicotine. In the related art, Patent No. CN202010054217.6 proposes to heat tobacco products to generate an aerosol through a heater having a spiral heating wire encapsulated in a ceramic or stainless steel outer sleeving formed by moulding or machining.

### SUMMARY

An embodiment of this application provides an aerosol generating apparatus configured to heat an aerosol-generating product to generate an aerosol. The apparatus includes:
a chamber, configured to receive the aerosol-generating product; and
a heater, at least partially extending into the chamber for insertion into the aerosol-generating product to heat the aerosol-generating product, where the heater has a free front end located in the chamber and a tail end away from the free front end.

The heater includes:
a housing element, extending between the free front end and the tail end, and at least partially defining an outer surface of the heater, where the housing element is formed by winding a sheet including a metal or an alloy.

In some implementations, the sheet is continuous.

In some implementations, the housing element includes 2 winding layers to 10 winding layers.

In some implementations, the housing element is constructed in a tubular shape wound by the sheet including the metal or the alloy.

In some implementations, a thickness of the housing element is in a range of 0.1 mm to 0.5 mm.

In some implementations, an outer surface of the housing element is closed or sealed.

In some implementations, the sheet includes gold, silver, copper, aluminum, or an alloy thereof. The metals or alloys have higher thermal conductivity than other metals or alloys, which can transfer heat to the aerosol-generating product more quickly.

In some implementations, the sheet includes:
a metal or alloy layer; and
a stress compensation layer, bonded to the metal or alloy layer and configured to provide stress compensation during the winding of the sheet to prevent the metal or alloy layer from cracking or breaking.

In some implementations, the stress compensation layer is flexible.

In some implementations, a thickness of the metal or alloy layer is in a range of 0.5 μm to 30 μm.

In some implementations, the heater further includes:
a base body, at least partially accommodated in the housing element and extending in a length direction of the heater; and
a resistive heating element, accommodated in the housing element and surrounding at least part of the base body.

In a more preferred implementation, the base body includes a first section and a second section that arranged in sequence.

The first section is adjacent to and defines the free front end.

The housing element at least partially surrounds the second section and exposes the first section.

In some implementations, the resistive heating element is bonded to an outer side of the second section and surrounds at least part of the second section.

In some implementations, the housing element is constructed to abut against the resistive heating element and retain the resistive heating element on an outer side of the base body.

In some implementations, the housing element is configured to receive heat from the resistive heating element to heat the aerosol-generating product.

Another embodiment of this application further provides an aerosol generating apparatus configured to heat an aerosol-generating product to generate an aerosol. The apparatus includes:
a chamber, configured to receive the aerosol-generating product; and
a heater, at least partially extending into the chamber for insertion into the aerosol-generating product to heat the aerosol-generating product, where the heater has a free front end for insertion into the aerosol-generating product and a tail end away from the free front end.

The heater includes:
a base body, extending between the free front end and the tail end, where the base body includes a first section close to the free front end and a second section close to the tail end;
a resistive heating coil, bonded to an outer side of the second section and surrounding at least part of the second section; and
a housing element, surrounding at least part of the resistive heating coil and exposing the first section, where the housing element includes at least two winding layers formed by winding a continuous sheet.

In some implementations, a cross section of a wire material of the resistive heating coil has a first dimension extending in an axial direction and a second dimension extending in a radial direction, and the first dimension is greater than the second dimension.

In some implementations, the sheet includes at least one of a metal, an alloy, ceramic, or glass.

Another embodiment of this application further provides a heater for an aerosol generating apparatus. The heater is constructed in a shape of a pin or a needle or a sheet, and has a free front end and a tail end away from each other in a length direction. The heater includes:
a housing element, extending between the free front end and the tail end, and at least partially defining an outer surface of the heater, where the housing element includes at least two winding layers of a sheet having a metal or an alloy.

In the present aerosol generating apparatus, the housing element of the heater formed by winding the sheet having the metal or the alloy is more convenient to manufacture than conventional ceramic or stainless steel housings formed by moulding or machining.

### BRIEF DESCRIPTION OF THE DRAWINGS

One or more embodiments are exemplarily described with reference to figures in drawings corresponding to the embodiments, and the exemplary descriptions do not constitute a limitation on the embodiments. Elements in the drawings having same reference numerals are expressed as similar elements. Unless otherwise particularly stated, the figures in the drawings are not drawn to scale.

FIG. 1 shows an aerosol generating apparatus according to an embodiment.

FIG. 2 is a schematic diagram of an embodiment of a heater in FIG. 1.

FIG. 3 is a schematic diagram of a section of a housing element in FIG. 2.

FIG. 4 is a schematic diagram of the housing element in FIG. 3 after being unfolded.

FIG. 5 is a schematic diagram of a resistive heating element according to another embodiment.

FIG. 6 is a schematic diagram of another embodiment of the heater in FIG. 1.

In the drawings:
A. Aerosol-generating product;
10. Battery core; 20. Circuit; 30. Heater; 40. Opening;
31c. Resistive heating element; 32c. Base body; 33c. Electrode ring; 35c. Housing element; 36c. Fixed base;
31d. Resistive heating element; 32d. Base body; 25d. Housing element; 31e. Resistive heating coil;
310c. Free front end; 320c. Tail end; 321c. Section; 322c. Section; 341c. First wire; 342c. Second wire; 351c. End portion; 352c. End portion; 353c. Winding layer;
310d. Free front end; 321d. Section; 322d. Section; 341d. First wire; 342d. Second wire;
B1. Connection position; B2. Connection position; B3. Connection position; B4. Connection position.

### DETAILED DESCRIPTION

For ease of understanding of this application, this application is described below in more detail with reference to drawings and specific implementations.

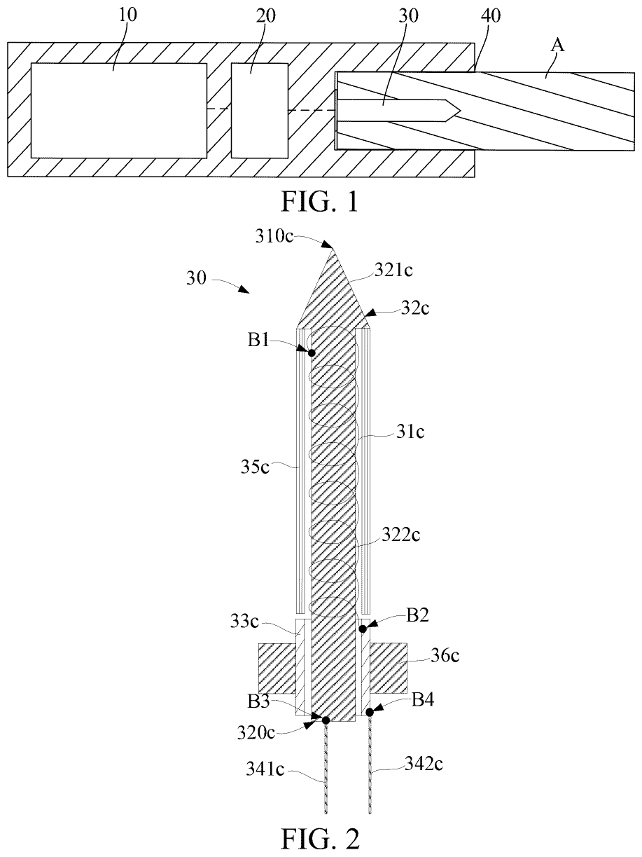

An embodiment of this application provides an aerosol generating apparatus. For a structure thereof, reference may be made to FIG. 1. The apparatus includes:
a chamber, having an opening 40, where an aerosol-generating product A may be removably received in the chamber through the opening 40 of the chamber during use;
a heater 30, at least partially extending into the chamber, where the heater is inserted into the aerosol-generating product A for heating when the aerosol-generating product A is received in the chamber, so that the aerosol-generating product A releases a plurality of types of volatile compounds, and the volatile compounds are formed merely by heating;
a battery core 10, configured to supply power; and
a circuit 20, configured to guide a current between the battery core 10 and the heater 30.

In some embodiments, the heater 30 is substantially in a shape of a pin, or a needle, or a stick, or a rod, or a post, or a sheet, or a plate, thereby facilitating insertion into the aerosol-generating product A. Moreover, the heater 30 may have a length in a range of about of about 12 millimeters (mm) to 20 mm and an outer diameter in a range of about 2 mm to 4 mm.

Further, in an optional implementation, the aerosol-generating product A is preferably made of a tobacco-containing material that releases a volatile compound from a substrate when being heated, or may be a non-tobacco material adapted for electric heating and generating smoke after being heated. The aerosol-generating product A is preferably made of a solid substrate. The solid substrate may include one or more of powders, particles, fragment strips, stripes, or flakes of one or more of vanilla leaves, tobacco leaves, homogeneous tobacco, and expanded tobacco. Alternatively, the solid substrate may include additional tobacco or non-tobacco volatile aroma compounds to be released when the substrate is heated.

In some implementations, the heater 30 may generally include a resistive heating element and auxiliary substrates for assisting in fixing and manufacturing of the resistive heating element. For example, in some implementations, the resistive heating element is in a shape or form of a spiral coil. Alternatively, in some other implementations, the resistive heating element is in a form of a conductive trajectory bonded to a substrate. Alternatively, in some other implementations, the resistive heating element is a shape of a thin substrate.

Further, FIG. 2 to FIG. 4 are schematic diagrams of a heater 30 according to an embodiment. The heater 30 in this embodiment includes:
a base body 32c, made of a rigid material such as ceramic or stainless steel, and extending in a length direction of the heater 30. The base body 32c has a section 321c and a section 322c. The section 321c is in a shape of a cone having a decreasing outer diameter, and defines a free front end 310c of the heater 30. The section 322c is in a shape of a stick or a rod having a substantially constant outer diameter.

A resistive heating element 31c, such as a resistive heating coil, surrounds the section 322c of the base body 32c.

In some optional implementations, the resistive heating element 31c is a conventional resistive heating coil formed by winding a wire material with a circular section. Alternatively, in some preferred implementations, the resistive heating coil is a resistive heating coil formed by winding a wire material with a flat or rectangular section. For example, in a resistive heating coil 31e shown in FIG. 5, the wire material has a larger extension dimension in an axial direction than in a radial direction, so that the resistive heating coil 31e constructed by the spiral coil is flat in the axial direction, thereby facilitating transfer of heat. In a specific implementation, the extension dimension of the wire material of the resistive heating coil 31e in the axial direction is in a range of 0.25 mm to 2 mm, and the extension dimension in the radial direction is in a range of 0.05 mm to 0.2 mm.

In terms of a design of a power supply structure for the resistive heating element 31c, the heater 30 includes:
an electrode ring 33c, close to a tail end 320c and surrounding at least part of the base body 32c, where
the base body 32c is made of a conductive material, such as stainless steel or a nickel-iron alloy; and
an upper end of the resistive heating element 31c close to the free front end 310c is connected to the base body 32c at a connection position B1 by welding, crimping, or the like, and a lower end of the resistive heating element 31c close to the tail end 320c is connected to the electrode ring 33c at a connection position B2 by welding, crimping, or the like;
a first wire 341c, connected to the base body 32c at a connection position B3 by welding, crimping, or the like, thereby being indirectly connected to the upper end of the resistive heating element 31c; and
a second wire 342c, connected to the electrode ring 33c at a connection position B4 by welding, crimping, or the like, thereby being indirectly connected to the lower end of the resistive heating element 31c.

Then the first wire 341c and the second wire 342c are connected to the circuit 20 to supply power to the resistive heating element 31c.

In addition, the heater 30 further includes:
a housing element 35c, surrounding the resistive heating element 31c and the section 322c of the base body 32c, where the housing element 35c is kept away from the section 321c of the base body 32c and the electrode ring 33c. After being fitted, the housing element 35c limits and retains the resistive heating element 31c on the section 322c of the base body 32c, to prevent the resistive heating element 31c from loosening or moving. Moreover, after being fitted, the housing element 35c at least partially defines an outer surface of the heater 30.

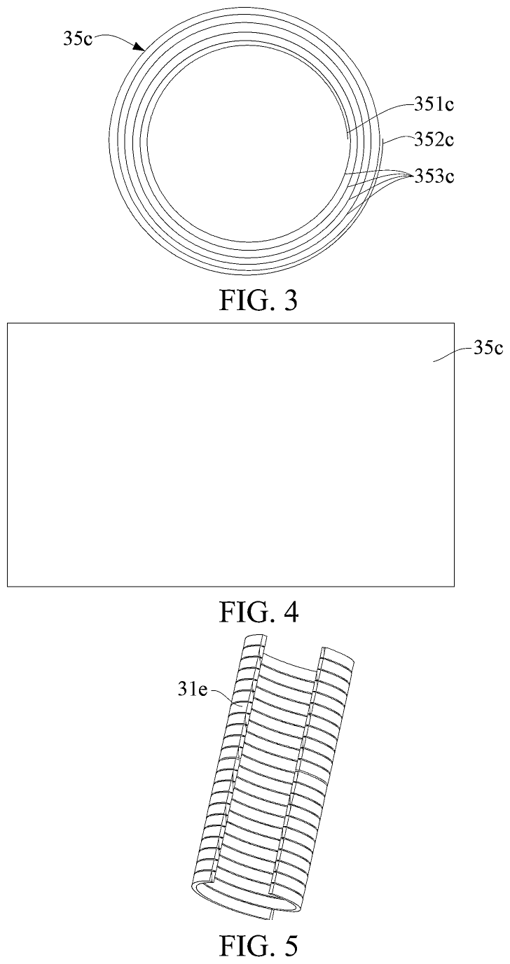

Further, FIG. 3 is a schematic diagram of a section of the housing element 35c. FIG. 4 is a schematic diagram of the housing element 35c after being unfolded. The housing element 35c is formed by winding a continuous foil or sheet outside the resistive heating element 31c. In an implementation, the foil or the sheet forming the housing element 35c is a metal foil (such as a stainless steel foil or a NiCr alloy foil) and a non-metallic foil (such as a ceramic/glass casting sheet). In a more preferred implementation, the foil or the sheet forming the housing element 35c is a foil or a sheet made of a metal or an alloy with a high thermal conductivity, for example, a foil or a sheet made of gold, silver, copper, aluminum, or an alloy thereof.

As shown in FIG. 4, the foil or the sheet wound to form the housing element 35c is in a shape of a continuous rectangle or strip or the like.

In some implementations, the sheet wound to form the housing element 35c is a single layer of foil made of a metal or an alloy. In some other more preferred implementations, the sheet wound to form the housing element 35c is a sheet including at least two composite layers. In a specific implementation, the sheet wound to form the housing element 35c includes:
a metal or alloy layer; and
a stress compensation layer, bonded to the metal or alloy layer, where the stress compensation layer provides stress compensation for bending or twisting during winding, to prevent a metal or alloy layer with a relatively high brittleness from cracking or breaking during the winding.

In some implementations, the stress compensation layer is a flexible layer. Specifically, the stress compensation layer is made of a flexible polymer material, for example, polyimide, free polypropylene, or polyethylene.

The metal or alloy layer has a thickness in a range of about 0.5 μm to 30 μm. The stress compensation layer has a same thickness as the metal or alloy layer, and is formed on at least one side surface of the metal or alloy layer by coating or deposition.

Further, according to the preferred implementation as shown in FIG. 3, the housing element 35c in a tubular shape formed by winding the foil or the sheet has a wall thickness in a range of about 0.1 mm to 0.5 mm. In addition, the housing element 35c has about 2 to 10 coils between an innermost end 351c and an outermost end 352c.

In a specific calculation, for example, in FIG. 3, the winding of the foil or the sheet is performed from inside to outside. Stating from the innermost end 351c, 1 winding is counted when the foil or the sheet is wound by 360 degrees. For example, in FIG. 3, the outermost end 352c and the innermost end 351c are substantially in a same radial position. In a specific implementation of FIG. 3, the housing element 35c has 6 winding layers, and 6 winding layers 353c are formed between the outermost end 352c and the innermost end 351c.

Further, the innermost end 351c of the housing element 35c is fixed through abutment of attachment of the resistive heating element 31c. To prevent the outermost end 352c from loosening, the outermost end 352c is formed through inorganic glue, glaze, or solder connection after the winding, to form a closed or sealed outer surface of the housing element 31, thereby preventing an aerosol, a condensate, or a residue of the aerosol-generating product A from entering the winding layers. Alternatively, in some other implementations, when the housing element 35c is manufactured by winding a non-metallic foil (such as a ceramic/glass casting sheet), the housing element is cured by interlayer welding or sintering after the winding to form a closure or a seal at the outermost end 352c.

During the manufacturing of the heater 30, after the resistive heating element 31c is formed by winding outside the housing element 35c, air in the housing element 35c may be further removed by heating and pressing, and a material of the above inorganic glue, glaze, or solder connection is cured to improve strength of the housing element 35c as a housing of the heater 30.

In some other implementations, electrical insulation between the housing element 35c and the resistive heating element 31c is implemented through an insulating layer or an insulating filler. Alternatively, an insulating material included in the sheet of the housing element 35c, for example, a material of the above stress compensation layer, or a ceramic or glass material, provides insulation.

In the preferred embodiment shown in FIG. 2, the heater 30 further includes:
a flange or fixed base 36c surrounding and bonded to the electrode ring 33c. A material of the flange or fixed base 36c is usually ceramic or a heat-resistant organic material such as PEEK or Teflon. During fitting, the aerosol generating apparatus holds or abuts against the flange or fixed base 36c, so that the heater 30 is stably fitted in the aerosol generating apparatus.

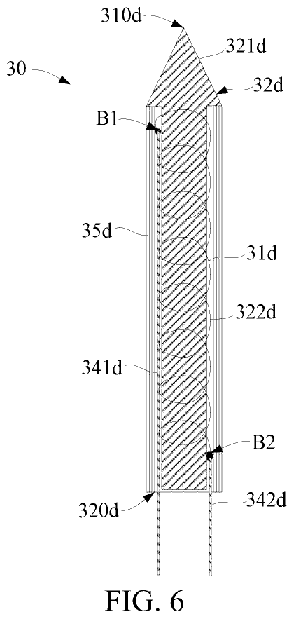

Alternatively, further, FIG. 6 is a schematic diagram of a heater 30 according to another variable embodiment. The heater 30 in this embodiment includes:
a base body 32d, having a section 321d and a section 322d, where the section 321d is in a shape of a cone and defines a free front end 310d of the heater 30, and the section 322d is in a shape of a stick, or a rod, or a post having a substantially constant outer diameter;
a resistive heating element 31d, such as a resistive heating coil, arranged around the section 322d of the base body 32d, where
an upper end of the resistive heating element 31d is directly connected to a first wire 341d at a connection position B1 by welding, crimping, or the like, and a lower end of the resistive heating element 31d is directly connected to a second wire 342d at a connection position B2 by welding, crimping, or the like;
a housing element 35c, surrounding the resistive heating element 31d and the section 322d of the base body 32d, where the housing element 35d is kept away from the section 321d of the base body 32d. After being fitted, the housing element 35d limits and retains the resistive heating element 31d on the section 322d of the base body 32d, to prevent the resistive heating element 31d from loosening or moving. Moreover, after being fitted, the housing element 35d at least partially defines an outer surface of the heater 30.

In some implementations, the housing element 35d is formed by winding the above foil or sheet having the thickness in the range of 0.5 μm to 30 μm described above. In addition, the foil or the sheet is a metal foil (such as a stainless steel foil or a NiCr alloy foil) and a non-metallic foil (such as a ceramic/glass casting sheet). In a more preferred implementation, the foil or the sheet forming the housing element 35d is a foil or a sheet made of a metal or an alloy with a high thermal conductivity, for example, a foil or a sheet made of gold, silver, copper, aluminum, or an alloy thereof.

According to the above heater 30, the housing or the outer surface of the heater 30 is at least partially defined by the housing element 35d formed by winding the foil or the sheet, so that a heat flow can rotate on a surface of the resistive heating element 31d, and a temperature field distribution on the surface of the heater 30 can be equalized more effectively.

Alternatively, further, in some implementations, a protective coating, such as a smoother aqueous nano-ceramic coating or a smoother glass glaze layer, may be further formed on a surface of the housing element 35c/35d of the heater 30 after the winding, so as to prevent an organic matter or a condensate from the aerosol-generating product A from attaching to or corroding the surface of the housing element 35c/35d.

It is to be noted that, although the specification and the drawings of this application provide the preferred embodiments of this application, this application is not limited to the embodiments described in this specification. Further, a person of ordinary skill in the art may make improvements or modifications according to the above descriptions, and all of the improvements and modifications shall fall within the protection scope of the appended claims of this application.

1. An aerosol generating apparatus, configured to heat an aerosol-generating product to generate an aerosol, comprising:
a chamber, configured to receive the aerosol-generating product; and
a heater, at least partially extending into the chamber for insertion into the aerosol-generating product to heat the aerosol-generating product, wherein the heater has a free front end located in the chamber and a tail end away from the free front end, and the heater comprises:
a housing element, extending between the free front end and the tail end, and at least partially defining an outer surface of the heater, wherein the housing element is formed by winding a sheet comprising a metal or an alloy.

2. The aerosol generating apparatus according to claim 1, wherein the sheet is continuous.

3. The aerosol generating apparatus according to claim 1, wherein the housing element comprises 2 winding layers to 10 winding layers.

4. The aerosol generating apparatus according to claim 1, wherein the housing element is constructed in a tubular shape wound by the sheet comprising the metal or the alloy.

5. The aerosol generating apparatus according to claim 4, wherein a thickness of the housing element is in a range of 0.1 mm to 0.5 mm.

6. The aerosol generating apparatus according to claim 4, wherein an outer surface of the housing element is closed or sealed.

7. The aerosol generating apparatus according to claim 1, wherein the sheet comprises:
a metal or alloy layer; and
a stress compensation layer, bonded to the metal or alloy layer and configured to provide stress compensation during the winding of the sheet to prevent the metal or alloy layer from cracking or breaking.

8. The aerosol generating apparatus according to claim 7, wherein the stress compensation layer is flexible.

9. The aerosol generating apparatus according to claim 7, wherein a thickness of the metal or alloy layer is in a range of 0.5 μm to 30 μm.

10. The aerosol generating apparatus according to claim 1, wherein the heater further comprises:
a base body, at least partially accommodated in the housing element and extending in a length direction of the heater; and
a resistive heating element, accommodated in the housing element and surrounding at least part of the base body.

11. The aerosol generating apparatus according to claim 10, wherein the base body comprises a first section and a second section arranged in sequence;
the first section is adjacent to and defines the free front end; and
the housing element at least partially surrounds the second section and exposes the first section.

12. The aerosol generating apparatus according to claim 11, wherein the resistive heating element is bonded to an outer side of the second section and surrounds at least part of the second section.

13. The aerosol generating apparatus according to claim 10, wherein the housing element is constructed to abut against the resistive heating element and retain the resistive heating element on an outer side of the base body.

14. The aerosol generating apparatus according to claim 10, wherein the housing element is configured to receive heat from the resistive heating element to heat the aerosol-generating product.

15. An aerosol generating apparatus, configured to heat an aerosol-generating product to generate an aerosol, comprising:
a chamber, configured to receive the aerosol-generating product; and
a heater, at least partially extending into the chamber for insertion into the aerosol-generating product to heat the aerosol-generating product, wherein the heater has a free front end for insertion into the aerosol-generating product and a tail end away from the free front end, and the heater comprises:
a base body, extending between the free front end and the tail end, wherein the base body comprises a first section close to the free front end and a second section close to the tail end;
a resistive heating coil, surrounding at least part of the second section; and
a housing element, surrounding at least part of the resistive heating coil and exposing the first section, wherein the housing element comprises at least two winding layers formed by winding a continuous sheet.

16. The aerosol generating apparatus according to claim 15, wherein a cross section of a wire material of the resistive heating coil has a first dimension extending in an axial direction and a second dimension extending in a radial direction, and the first dimension is greater than the second dimension.

17. The aerosol generating apparatus according to claim 15, wherein the sheet comprises at least one of a metal, an alloy, ceramic, or glass.

18. A heater for an aerosol generating apparatus, wherein the heater is constructed in a shape of a pin or a needle or a sheet, and has a free front end and a tail end away from each other in a length direction, and the heater comprises:
a housing element, extending between the free front end and the tail end, and at least partially defining an outer surface of the heater, wherein the housing element is formed by winding a sheet comprising a metal or an alloy.
